(19) United States
(12) Patent Application Publication
(10) Pub. No.: US 2010/0015531 A1
(43) Pub. Date: Jan. 21, 2010

(54) ENHANCED NEGATIVE PLATES FOR LEAD ACID BATTERIES

(75) Inventors: Enders Dickinson, V, Mount Pleasant, SC (US); Benjamin J. Craft, Mount Pleasant, SC (US)

Correspondence Address: MEADWESTVACO CORPORATION;ATTN: IP LEGAL DEPARTMENT, 1021 MAIN CAMPUS DRIVE, RALEIGH, NC, 27606, US

(73) Assignee: MEADWESTVACO CORPORATION, Glen Allen, VA (US)

(21) Appl. No.: 12/175,517

(22) Filed: Jul. 18, 2008

(51) Int. Cl. H01M 2/16; C01B 31/08

(52) U.S. Cl. 429/247; 423/445 R

(57) ABSTRACT

A paste for negative plate of lead acid battery is disclosed that has a reduced paste density, yet provides a negative plate with substantially increased BET surface area and consequently the battery with enhanced performance. The disclosed paste comprises an activated carbon additive having a mesopore volume of greater than about 0.1 cm³/g and a mesopore size range of about 20 angstroms to about 320 angstroms as determined by DFT nitrogen adsorption isotherm. The cured negative plate made of the disclosed paste has a BET surface area of about 9 m²/g and 19 m²/g when the carbon loading level of the paste is about 1% and 2% weight, respectively relative to dry paste lead oxide. The battery including the negative plate made of the disclosed paste maintains the performance such as charge capacity and cycle life, despite containing less lead.

### BACKGROUND OF THE DISCLOSURE

Lead acid battery is an electrochemical storage battery generally comprising a positive plate, a negative plate, and an electrolyte, which is typically aqueous sulfuric acid. The plates are held in a parallel orientation and electrically isolated by a porous separator to allow free movement of charged ions. The positive battery plate contains a current collector (i.e., a metal plate or grid) covered with a layer of positive, electrically conductive lead dioxide (PbO₂) on the surface. The negative battery plate contains a current collector covered with a negative, active material, which is typically lead (Pb) metal.

During a discharge cycle, lead metal (Pb) supplied by the negative plate reacts with the ionized sulfuric acid electrolyte to form lead sulfate (PbSO₄) on the surface of the negative plate, while the PbO₂ located on the positive plate is converted into PbSO₄ on or near the positive plate. During a charging cycle (via an electron supply from an external electrical current), PbSO₄ on the surface of the negative plate is converted back to Pb metal, and PbSO₄ on the surface of the positive plate is converted back to PbO₂. In effect, a charging cycle converts PbSO₄ into Pb metal and PbO₂; a discharge cycle releases the stored electrical potential by converting PbO₂ and Pb metal back into PbSO₄.

To function properly, lead acid batteries require the negative plate to remain porous. However, the surface of the spongy lead on the negative plate can become covered by an impenetrable film of PbSO₄ that forms during discharge. Accordingly, an expander is added in small amounts to the negative active material to prevent the contraction and solidification of the Pb metal of the negative plate, and thus preventing the contraction or the closing of the pores in the negative plate. Examples of organic expander additives include lignins, ligneous materials, humins, humic acids, organic material from sulfite and sulfate liquors, and the like.

Recently, lead acid batteries have been used as an electric source for an electric car, which requires a large current and repetition of charging and discharging. Furthermore, the battery used in an electric car must be arranged in a narrow space in order to maximize the interior space of the car.

For the conventional negative electrode plate of lead acid battery, it is difficult to obtain life performance satisfactory for use under a high temperature, such as in the lead acid battery for an electric vehicle as described above. Lignin and other organic expanders often decompose in an early stage or elude into the electrolyte, especially when used under high temperature, resulting in a reduction of service life of the battery.

Furthermore, many emerging end-uses for lead acid battery require high input and output characteristics, along with high percentage charge performance (i.e. high input performance in a short time). The high charge performance largely depends on the characteristics of PbSO₄ present on the negative plate. The PbSO₄ generated during the discharge cycle becomes an insulating substance devoid of either ion conductivity or electronic conductivity. Additionally, PbSO₄ has very poor solubility. Due to its extremely poor ion conductivity and solubility, PbSO₄ converts to metallic Pb very slowly during the charge cycle and the lead acid battery often has a low percentage charge performance.

Additives can be added to the paste used in the negative plate of lead acid battery, in addition to the conventional expander like lignin, to enhance the service life and to increase the high percentage charge performance of the battery.

U.S. Pat. No. 6,740,452 uses carbon black as an additive in the negative battery paste for lead acid battery, in combination with an inorganic expander such as a barium containing material and an organic expander such as lignosulfonate. U.S. Pat. No. 5,223,352 describes the use of dimensionally isotropic graphite fiber from either polyacrylonitrile (PAN) precursor or pitch precursor as an additive to the active material from which the plates of lead-acid batteries are formed. U.S. Pat. No. 5,156,935 describes electro-conductive whiskers made of carbon, graphite or potassium titanate, useful as additives for the negative plate of a lead acid battery, having a diameter of 10 micron or less, aspect ratio of 50 or more, and a specific surface area of 2 m²/g. U.S. Pat. No. 5,547,783 discloses conductive additives for the negative plate of a lead acid battery, having an average particle diameter of 100 nanometers or less. These additives may be carbon, acetylene black, polyaniline, tin powder, or tin compound powder. U.S. Pat. No. 6,548,211 teaches the use of graphite powder having a mean particle size not more than 30 micron as an additive for the negative electrode plate for lead acid battery.

There are several drawbacks for using carbon black, graphite carbon, and their derivatives as additives for the negative plate pastes of lead acid battery. Carbon black and graphite each have very low density and very poor retention of particle size when being mixed into a paste and during charging cycle. As a result, they easily bleed out of the negative plate through a separator and increase self-discharge. Furthermore, graphite carbon can be intercalated by the sulfate when being exposed to typical operating voltages of lead acid battery, thus its effectiveness can be reduced significantly.

The negative plate paste for battery typically has an approximate density of 70 g/in³ to achieve standard battery capacity, charging, and lifetime performance. Negative plates with lower densities may conserve resources and reduce battery production costs. Unfortunately, negative plates with low densities typically perform poorly due to either mechanical deficiencies or insufficient chemical and/or electrochemical activities.

The paste density may be reduced by an addition of water and/or sulfuric acid into the paste mix. However, this often results in an insufficient paste adhesion and consequently, a reduction of plate integrity at the end of paste processing and/or after plate curing. The paste does not remain intact to the plate grid due to adhesion to equipments during paste processing. During plate curing, paste may “crumble” off the grid due to poor grid contact. Furthermore, poor adhesion of the paste to the cured plate results in handling issues.

U.S. Pat. No. 7,083,876 describes an additive for the negative electrode plate for lead acid battery comprising a catalyst for desulfurization or a catalyst for SOx oxidation supported on a carbon material such as active carbon, carbon black, and the like. The negative plate formed from such carbon additives exhibits reduced plate density. However, the obtained negative plate has decreased surface area, thereby worsening the performance of lead-acid containing thereof.

Accordingly, there remains the need for a negative plate paste having lower density to conserve resources and reduce battery production costs, yet maintaining, if not enhancing, the performance of the negative plate making thereof.

Furthermore, it is desirable to have a lead acid battery with increased cycle life, enhanced capacity and charging characteristics compared to conventional lead acid batteries.

### SUMMARY OF THE DISCLOSURE

A paste for negative plate of lead acid battery is disclosed that has a reduced paste density, yet provides a negative plate with substantially increased BET surface area and consequently the battery with enhanced performance. The disclosed paste comprises an activated carbon additive having a mesopore volume of greater than about 0.1 cm³/g and a mesopore size range of about 20 angstroms to about 320 angstroms as determined by DFT nitrogen adsorption isotherm. The cured negative plate made of the disclosed paste has a BET surface area of about 9 m²/g and 19 m²/g when the carbon loading level of the paste is about 1% and 2% weight, respectively relative to dry paste lead oxide. The battery including the negative plate made of the disclosed paste maintains the performance such as charge capacity and cycle life, despite containing less lead.

### DESCRIPTION OF FIGURES

FIG. 1 is a graph showing wet paste densities at different additive loading levels, comparing the paste of present disclosure to the pastes containing coconut-based activated carbon, carbon black, flake graphite, expanded graphite, or a mixture of graphite and carbon black;

FIG. 2 is a graph showing BET surface area of cured negative plates at different additive loading levels, comparing the negative plate containing the disclosed paste to the negative plates made of the pastes containing coconut-based activated carbon, carbon black, flake graphite, or expanded graphite;

FIG. 3 is a graph showing reserve capacity and cold cranking performance of the lead acid batteries having the negative plates made of different pastes: the disclosed paste at 1% carbon load, the paste containing coconut-based activated carbon at 1% carbon load, and the paste without carbon additive; and

FIG. 4 is a graph showing cycle life of the lead acid batteries having the negative plates made of different pastes: the disclosed paste at 1% carbon load, the paste containing coconut-based activated carbon at 1% carbon load, and the paste without carbon additive.

### DETAILED DESCRIPTION OF THE DISCLOSURE

The present disclosures now will be described more fully hereinafter, but not all embodiments of the disclosure are necessarily shown. While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof.

The term “mesopore” of the present disclosure refers to the pore volume of greater than about 0.1 cm³/g and the pore size range of about 20 angstroms to about 320 angstroms as determined by DFT nitrogen adsorption isotherm.

The paste of the present disclosure is suitable for the negative plate of lead-acid battery. The disclosed paste includes an activated carbon additive having a mesopore volume of greater than about 0.1 cm³/g and a mesopore size range, as determined by DFT nitrogen adsorption isotherm, of about 20 angstroms to about 320 angstroms. In one embodiment of the present disclosure, the activated carbon additive has a mesopore volume range of about 0.1 cm³/g to about 1.5 cm³/g and a mesopore size range, as determined by DFT nitrogen adsorption isotherm, of about 20 angstroms to about 320 angstroms. The amount of activated carbon additive in the disclosed paste may be varied and optimized according to the targeted end use applications.

A variety of materials may be used in the present disclosure as carbon sources for the activated carbon. These include, but are not limited to, wood, cotton linters, peat, coal, coconut, lignite, carbohydrates, petroleum pitch, petroleum coke, coal tar pitch, fruit pits, nut shells, nut pits, sawdust, wood flour, carbon black, graphite, acetylene-based materials, synthetic polymer, and natural polymer, and combinations thereof. Furthermore, the activated carbon may be produced using a variety of processes including, but not limited to, chemical activation, thermal activation, and combinations thereof.

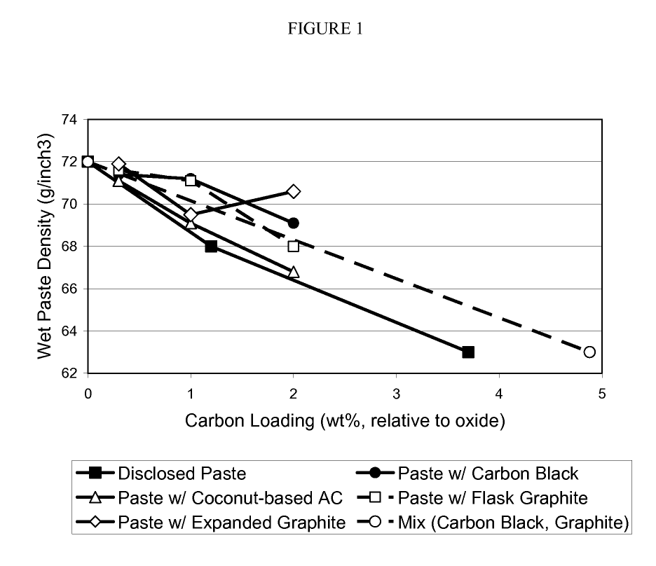

The disclosed pastes containing different loading levels of activated carbon additive were prepared. The densities of the disclosed pastes were measured and compared to those of the pastes having different carbon additives. The comparative carbon additives were coconut-based activated carbon, carbon black, graphite carbon, and a mixture of carbon black and graphite. At the same loading level, the wet paste densities of the disclosed paste and the paste containing coconut-based activated carbon exhibited lower paste densities compared to those of the pastes containing carbon black, graphite carbon, or combinations thereof. (FIG. 1) When the negative paste was loaded with greater than 1% by weight (relative to oxide) of carbon additive, the pastes with activated carbon additives showed significantly lower density compared than those with graphite or carbon black additives.

The negative plate of the present disclosure is produced by a process comprising steps of:
(a) providing a paste mixture including an activated carbon with a mesopore volume of greater than about 0.1 cm³/g and a mesopore size range, as determined by DFT nitrogen adsorption isotherm, of about 20 angstroms to about 320 angstroms; and
(b) processing the paste mixture into the negative plate.

In one embodiment of the present disclosure, the negative plate is produced by a process comprising steps of:
(a) providing a paste mixture including an activated carbon with a mesopore volume range of about 0.1 cm³/g to about 1.5 cm³/g and a mesopore size range, as determined by DFT nitrogen adsorption isotherm, of about 20 angstroms to about 320 angstroms; and
(b) processing the paste mixture into the negative plate.

The cured negative plate for lead acid battery made of the disclosed paste exhibits unexpectedly much higher BET surface area compared to the equivalent negative plates made of pastes containing different carbon additives, and therefore provides the battery with far superior performance compared to the known lead acid batteries.

The negative plates made of the disclosed pastes having different loading levels of activated carbon additives were prepared and cured. The BET surface area (nitrogen adsorption) of the resulting cured negative plates were measured and compared to those of the negative plates containing different carbon additives at same loading levels. The comparative carbon additives were coconut-based activated carbon, carbon black, flake graphite, and expanded graphite. (TABLE 1)

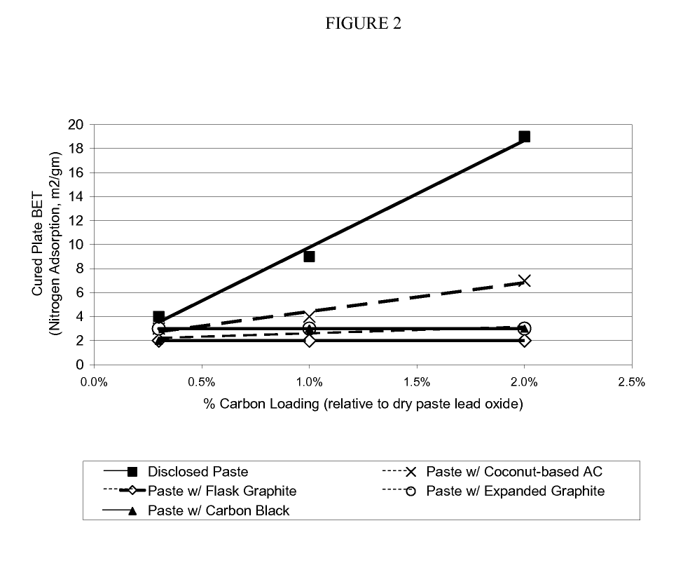

At the carbon additive loading level above about 0.3% by weight relative to dry paste lead oxide, the BET surface area of the cured negative plate of the present disclosure was unexpectedly much higher than those of the negative plates containing comparative carbon additives. At the carbon additive loading of about 1% by weight relative to dry paste lead oxide, the disclosed negative plate exhibited a BET surface area of about 9 m²/g, while the negative plate made of the paste containing coconut-based activated carbon showed the BET surface area of about 4 m²/g. At the same carbon additive load level, the BET surface area of the negative plates made of the pastes containing carbon black, flake graphite, and expanded graphite were only about 3, 2, and 3 m²/g, respectively. At the carbon additive loading of about 2% by weight relative to dry paste lead oxide, the disclosed negative plate exhibited a BET surface area of about 19 m²/g, while the negative plate made of the paste containing coconut-based activated carbon showed the BET surface area of only about 7 m²/g. At the same carbon additive load level, the BET surface area of the negative plates made of the pastes containing carbon black, flake graphite, and expanded graphite were only the about 3, 2, and 3 m²/g, respectively. (FIG. 2)

TABLE 1

| | BET Surface of the Cured Negative Plate | | |
|---|---|---|---|
| | (Nitrogen Adsorption, m²/g) | | |
| | 0.3% by wt | 1.0% by wt | 2.0% by wt |
| Paste for | relative to | relative to | relative to |
| the Negative Plate | lead oxide | lead oxide | lead oxide |
| Disclosed Paste | 4 | 9 | 19 |
| Coconut-based Activated | 3 | 4 | 7 |
| Carbon as Additive | | | |
| Carbon Black as Additive | 2 | 3 | 3 |
| Flake Graphite as Additive | 2 | 2 | 2 |
| Expanded Graphite as | 3 | 3 | 3 |
| Additive | | | |
| No Carbon Additive | 2 | 2 | 2 |

The wet density of the paste containing activated carbon additive is lower than those of the pastes containing carbon black, flake graphite, or expanded graphite. As expected, the paste containing activated carbon additive provides a cured negative plate with higher BET surface area than pastes containing carbon black, flake graphite, or expanded graphite additive. The disclosed paste has about the same wet density as the paste containing coconut-based activated carbon additive. One skilled in the art skill, therefore, would expect the cured negative plate made of the disclosed paste to have about the same BET surface area as the negative plate made of the paste containing coconut-based activated carbon additive. The disclosed negative plate made of the disclosed paste, however, exhibits unexpectedly much higher BET surface area than the negative plates made of the paste containing coconut-based activated carbon.

Additionally, the density of the paste of the present disclosure may be reduced without any significant deleterious effect on the battery performance such as reserve capacity, cold cranking performance, and cycle life.

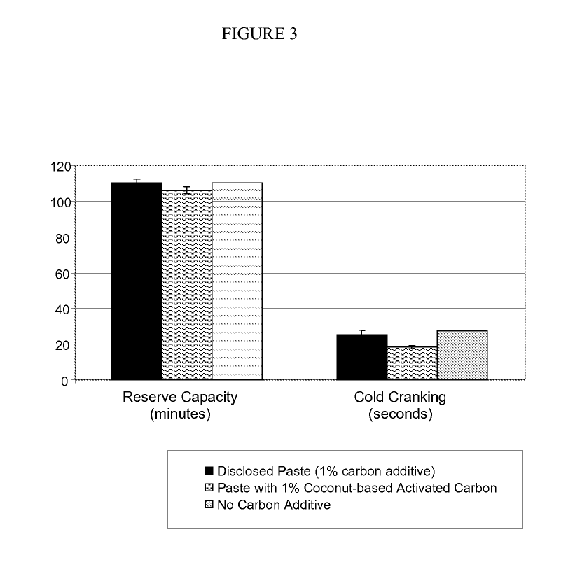

The reserve capacity and cold cranking performance of the batteries were tested according to the Society of Automotive Engineering Standard SAE J537 protocol for storage batteries. The lead acid battery including a negative plate made of the disclosed paste containing 1% weight (relative to oxide) activated carbon additive had about the same reserve capacity and cold cranking performance as the equivalent battery having the negative plate made of the paste containing no carbon additive. (FIG. 3)

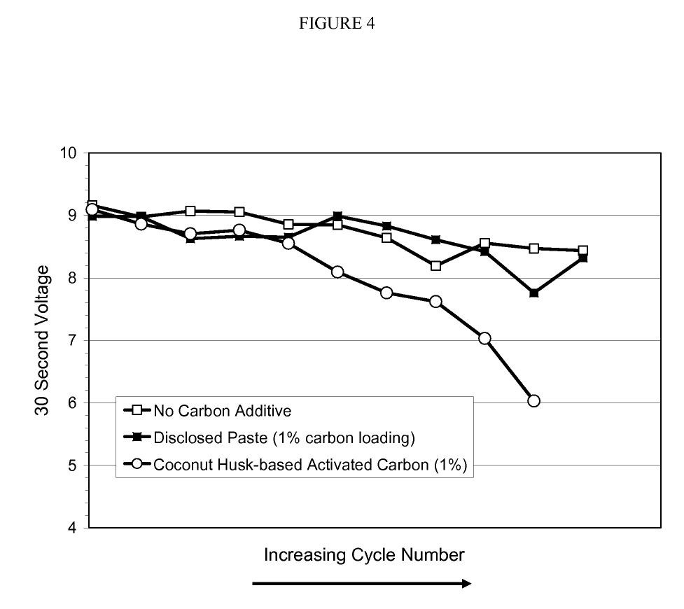

The battery cycle life was tested according to the Society of Automotive Engineering Standard SAE J240 protocol for automotive storage batteries. As shown in FIG. 4, the cycle life of lead acid battery including the negative plate made of the disclosed paste with an activated carbon loading of about 1% by weight relative to oxide, had approximately the same cycle life performance as that of the equivalent battery having the negative plate made of the paste containing no carbon additive. Contrary, the cycle life of the equivalent battery including the negative plate made of the paste containing coconut-based activated carbon at the same loading level is substantially shortened.

The lead acid battery of the present disclosure has increased service life and improved charge capacity. The disclosed battery may be used as an energy source for several applications. These include, but are not limited to, electric vehicles, hybrid vehicles, electromotive tools such as fork lift and specialized short range utility vehicles, power conversion and storage systems, telecommunication stations, elevators, and power source systems such as uninterruptible power source, distributed power source and the like, and any other systems requiring stable control and high input and output characteristics.

The foregoing description relates to embodiments of the present invention, but it is to be understood that changes and modifications may be made therein as will be apparent to those skilled in the art. Such variations are to be considered within the scope of the invention as defined in the following claims.

We claim:

1. A paste suitable for a negative plate of battery, including an activated carbon having a mesopore volume of greater than about 0.1 cm³/g and a mesopore size range, as determined by DFT nitrogen adsorption isotherm, of about 20 angstroms to about 320 angstroms.

2. The paste of claim 1, wherein the activated carbon has the mesopore volume range of about 0.1 cm³/g to about 1.5 cm³/g.

3. The paste of claim 1, wherein a source of the activated carbon includes a member selected from the group consisting of wood, cotton linters, peat, coal, coconut, lignite, carbohydrates, petroleum pitch, petroleum coke, coal tar pitch, fruit pits, nut shells, nut pits, sawdust, wood flour, carbon black, graphite, acetylene-based materials, synthetic polymer, natural polymer, and combinations thereof.

4. The paste of claim 1, wherein the activated carbon is produced by an activation process including a member selected from the group consisting of chemical activation, thermal activation, and combinations thereof.

5. A paste suitable for a negative plate of battery, including carbon-based additive and providing the negative plate with a BET surface area of at least about 5 m²/g at an carbon additive loading level of about 1% by weight relative to dry paste lead oxide.

6. The paste of claim 5, wherein the carbon-based additive includes an activated carbon.

7. The paste of claim 6, wherein a source of the activated carbon includes a member selected from the group consisting of wood, cotton linters, peat, coal, coconut, lignite, carbohydrates, petroleum pitch, petroleum coke, coal tar pitch, fruit pits, nut shells, nut pits, sawdust, wood flour, carbon black, graphite, acetylene-based materials, synthetic polymer, natural polymer, and combinations thereof.

8. The paste of claim 6, wherein the activated carbon is produced by an activation process including a member selected from the group consisting of chemical activation, thermal activation, and combinations thereof.

9. A paste suitable for a negative plate of battery, including carbon-based additive and providing the negative plate with a BET surface area of at least about 8 m²/g at an carbon additive loading level of about 2% by weight relative to dry paste lead oxide.

10. The paste of claim 9, wherein the carbon-based additive includes an activated carbon.

11. The paste of claim 10, wherein a source of the activated carbon includes a member selected from the group consisting of wood, cotton linters, peat, coal, coconut, lignite, carbohydrates, petroleum pitch, petroleum coke, coal tar pitch, fruit pits, nut shells, nut pits, sawdust, wood flour, carbon black, graphite, acetylene-based materials, synthetic polymer, natural polymer, and combinations thereof.

12. The paste of claim 10, wherein the activated carbon is produced by an activation process including a member selected from the group consisting of chemical activation, thermal activation, and combinations thereof.

13. A negative plate for battery, comprising an activated carbon having a mesopore volume of greater than about 0.1 cm³/g and a mesopore size range, as determined by DFT nitrogen adsorption isotherm, of about 20 angstroms to about 320 angstroms.

14. The negative plate of claim 13, wherein the activated carbon has the mesopore volume range of about 0.1 cm³/g to about 1.5 cm³/g.

15. The negative plate of claim 13, wherein a source of the activated carbon includes a member selected from the group consisting of wood, cotton linters, peat, coal, coconut, lignite, carbohydrates, petroleum pitch, petroleum coke, coal tar pitch, fruit pits, nut shells, nut pits, sawdust, wood flour, carbon black, graphite, acetylene-based materials, synthetic polymer, natural polymer, and combinations thereof.

16. The negative plate of claim 13, wherein the activated carbon is produced by an activation process including a member selected from the group consisting of chemical activation, thermal activation, and combinations thereof.

17. A negative plate for battery, comprising a paste that includes a carbon-based additive and having a BET surface area of at least about 5 m²/g when an amount of the carbon additive in the paste is about 1% by weight relative to dry paste lead oxide.

18. The negative plate of claim 17, wherein the carbon-based additive includes an activated carbon.

19. The plate of claim 18, wherein a source of the activated carbon includes a member selected from the group consisting of wood, cotton linters, peat, coal, coconut, lignite, carbohydrates, petroleum pitch, petroleum coke, coal tar pitch, fruit pits, nut shells, nut pits, sawdust, wood flour, carbon black, graphite, acetylene-based materials, synthetic polymer, natural polymer, and combinations thereof.

20. The plate of claim 18, wherein the activated carbon is produced by an activation process including a member selected from the group consisting of chemical activation, thermal activation, and combinations thereof.

21. A negative plate for battery, comprising a paste that includes a carbon-based additive and having a BET surface area of at least about 8 m²/g when an amount of the carbon additive in the paste is about 2% by weight relative to dry paste lead oxide.

22. The negative plate of claim 21, wherein the carbon-based additive includes an activated carbon.

23. The plate of claim 22, wherein a source of the activated carbon includes a member selected from the group consisting of wood, cotton linters, peat, coal, coconut, lignite, carbohydrates, petroleum pitch, petroleum coke, coal tar pitch, fruit pits, nut shells, nut pits, sawdust, wood flour, carbon black, graphite, acetylene-based materials, synthetic polymer, natural polymer, and combinations thereof.

24. The plate of claim 22, wherein the activated carbon is produced by an activation process including a member selected from the group consisting of chemical activation, thermal activation, and combinations thereof.

25. A battery, including a negative plate made of a paste comprising an activated carbon having a mesopore volume of greater than about 0.1 cm³/g and a mesopore size range, as determined by DFT nitrogen adsorption isotherm, of about 20 angstroms to about 320 angstroms.

26. The battery of claim 25, wherein the activated carbon has the mesopore volume range of about 0.1 cm³/g to about 1.5 cm³/g.

27. The battery of claim 25, wherein a source of the activated carbon includes a member selected from the group consisting of wood, cotton linters, peat, coal, coconut, lignite, carbohydrates, petroleum pitch, petroleum coke, coal tar pitch, fruit pits, nut shells, nut pits, sawdust, wood flour, carbon black, graphite, acetylene-based materials, synthetic polymer, and natural polymer, and combinations thereof.

28. The battery of claim 25, wherein the activated carbon is produced by an activation process including a member selected from the group consisting of chemical activation, thermal activation, and combinations thereof.

29. A battery, including a negative plate that comprises a carbon-based additive and has a BET surface area of at least about 5 m²/g when an amount of the carbon additive in the paste is about 1% by weight relative to dry paste lead oxide.

30. The battery of claim 29, wherein the carbon-based additive includes an activated carbon.

31. A battery, including a negative plate that comprises a carbon-based additive and has a BET surface area of at least about 8 m²/g when an amount of the carbon additive in the paste is about 2% by weight relative to dry paste lead oxide.

32. The battery of claim 31, wherein the carbon-based additive includes an activated carbon.
